(19) United States
(12) Patent Application Publication
(10) Pub. No.: US 2007/0005834 A1
(43) Pub. Date: Jan. 4, 2007

(54) Memory chips with buffer circuitry

(75) Inventor: Melik Isbara, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/174,314

(22) Filed: Jun. 30, 2005

(51) Int. Cl. G06F 5/00

(52) U.S. Cl. 710/52

(57) ABSTRACT

In some embodiments, a memory chip includes receivers to receive signals from outside the chip and transmitters to transmit signals to outside the chip. The chip also includes a memory core and buffer circuitry to hold the signals received by the receivers and, under at least some circumstances, to provide the held signals for use by both the memory core and the transmitters. Other embodiments are described and claimed.

### BACKGROUND

### TECHNICAL FIELD

The present inventions relate to memory chips that include buffer circuitry to provide data to multiple destinations.

### BACKGROUND ART

Various arrangements for memory chips in a memory system have been proposed. For example, in a traditional synchronous dynamic random access memory (DRAM) system, memory chips communicate data through bidirectional data buses and receive commands and addresses through command and addresses buses. The memory chips have stubs that connect to the buses.

In other memory systems, a memory chip receives signals and repeats them to a next memory chip in a series of two or more memory chips. In some of these systems, the last memory chip in the series can send a signal directly back to a memory controller or other originating chip. This is referred to as a ring.

Memory modules include a substrate on which a number of memory chips are placed. The memory chips may be placed on only one side of the substrate or on both sides of the substrate. In some systems, a buffer is also placed on the substrate. For at least some signals, the buffer interfaces between the memory controller and the memory chips on the module. In such a buffered system, the memory controller may use different signaling (for example, frequency and voltage values, and point-to-point versus a multi-drop arrangement) with the buffer than the buffer uses with the memory chips.

### BRIEF DESCRIPTION OF THE DRAWINGS

The inventions will be understood more fully from the detailed description given below and from the accompanying drawings of embodiments of the inventions which, however, should not be taken to limit the inventions to the specific embodiments described, but are for explanation and understanding only.

FIG. 1 is a block diagram representation of a system including a memory controller and first and second memory modules according to some embodiments of the inventions.

FIG. 2 is a block diagram representation of a memory device in FIG. 1 according to some embodiments of the inventions.

FIG. 3 is a block diagram representation of an alternative to some details of the memory device in FIG. 2 according to some embodiments of the inventions.

FIG. 4 is a block diagram representation of a memory device in FIG. 1 according to some embodiments of the inventions.

FIG. 5 is a block diagram representation of a system including a memory controller and first and second memory modules according to some embodiments of the inventions.

FIGS. 6-7 are each a block diagram representation of a memory device in FIG. 5 according to some embodiments of the inventions.

FIG. 8 is a block diagram representation of a system including a memory controller and first and second memory modules according to some embodiments of the inventions.

FIG. 9 is a block diagram representation of a memory device in FIG. 8 according to some embodiments of the inventions.

FIGS. 10-11 are each a block diagram representation of a system including a memory controller and modules including buffers according to some embodiments of the inventions.

FIGS. 12-13 are each a block diagram representation of a system including a memory controller according to some embodiments of the inventions.

### DETAILED DESCRIPTION

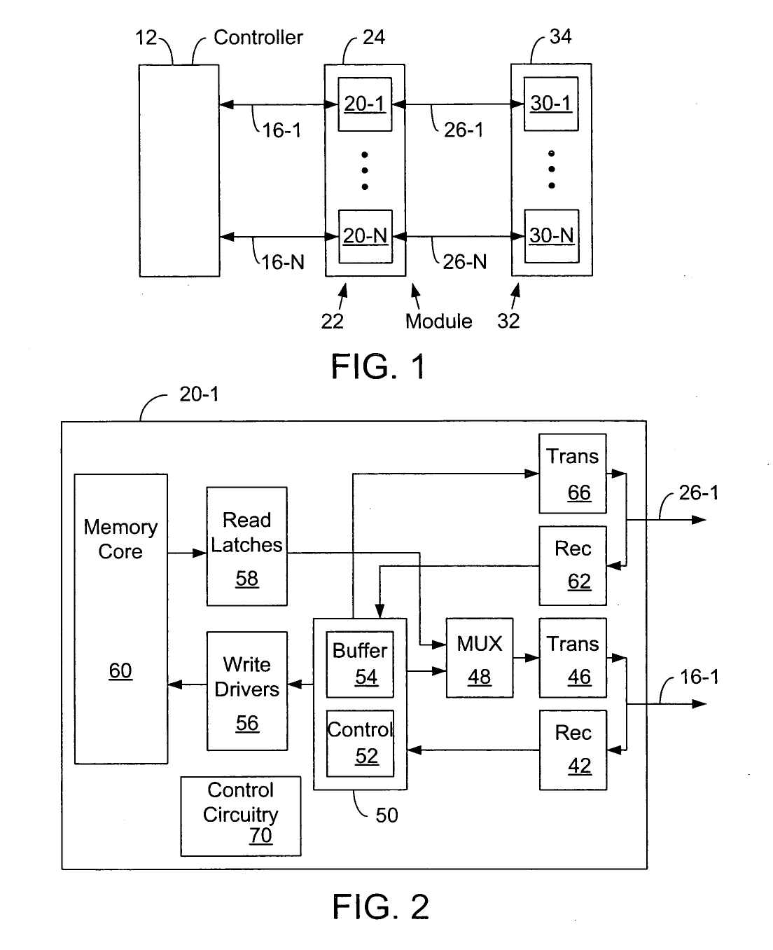

Referring to FIG. 1, a memory system includes a memory controller 12 which is coupled to memory chips 20-1 . . . 20-N on a substrate 24 of a module 22 through conductors 16-1 . . . conductors 16-N. Chips 20-1 . . . 20-N are in turn coupled to memory chips 30-1 . . . 30-N on a substrate 34 of a module 32 through conductors 26-1 . . . conductors 26-N. In the embodiments of FIG. 1, conductors 16-1 . . . conductors 16-N and conductors 26-1 . . . conductors 26-N carry signals bidirectionally. The signals may be carried bidirectionally in a sequential or simultaneous manner. Accordingly, conductors 16-1 . . . conductors 16-N carry signals from controller 12 to chips 20-1 . . . 20-N, and from chips 20-1 . . . 20-N to conductor 12. Likewise, conductors 26-1 . . . conductors 26-N carry signals from chips 20-1 . . . 20-N to chips 30-1 . . . 30-N, and from chips 30-1 . . . 30-N to chips 20-1 . . . 20-N. There may also be other conductors (not illustrated in FIG. 1) that carry signals unidirectionally or bidirectionally. The memory chips may be DRAMs or other types of memory chips.

FIG. 2 illustrates some details of chip 20-1 according to some embodiments. Of course, an actual chip may include circuitry in addition to what is illustrated in FIG. 2. Referring to FIG. 2, receivers 42 and transmitters 46 are coupled to conductors 16-1. Receivers 62 and transmitters 66 are coupled to conductors 26-1. Control circuitry 70 performs various control functions for chip 20-1. In some embodiments, there are decoders associated with the receivers and encoders associated with the transmitters, but that is not required for all embodiments.

Receivers 42 provide received signals to buffer circuitry 50. Buffer circuitry 50 includes control circuitry 52 and a buffer 54. Control circuitry 52 controls writing into and reading out of buffer 54. In some embodiments, buffer circuitry 50 is multiported allowing more rapid writing and reading of data into and out of buffer circuitry 50. In other embodiments, it is fully or partially single ported. In some embodiments, bits representing the same held (stored) signals are provided by buffer circuitry 50 toward memory core 60 and toward transmitters 66 at the same time and in other embodiments (or different modes of the same embodiments), bits representing the same stored signals are provided toward memory core 60 and toward transmitters 66 at the different times. Even though different bits represent the same received signal, it is said that the held received signal is provided to both memory core 60 and transmitters 66.

Buffer circuitry 50 could be referred to as multiple purpose buffer circuitry or as including a combined write buffer and input/output queue. It is called “combined” because buffer 54 serves the function of a write buffer and an input/output queue. Buffer 54 serves the function of a write buffer because it temporarily holds signals and then provides the signals to be written into a memory core 60 through write drivers 56. Buffer 54 serves the function of an input/output queue because it receives signals from receivers 62 and temporarily holds them and then provides them to multiplexer circuitry 48. Multiplexer circuitry 48 also receives read signals from memory core 60 through read latches 58. Multiplexer circuitry 48 selects which of signals from buffer circuitry 50 and read signals from read latches 58 are to be passed to transmitters 46 at particular times. Buffer 54 also serves the function of an input/output queue because it receives signals from receivers 42 and temporarily holds them and then provides them to transmitters 66.

An advantage of combining the write buffer and input/output functions can be understood by comparing it with a memory chip in which the write buffer and input/output queue are separate. In such an alternative chip, sometimes the write buffer would be full or substantially full and the input/output queue would be empty or not very full. At other times, the input/output queue would be full or substantially full and the write buffer would be empty or not very full. To handle each of these cases, to achieve a particular level of performance, the sum of the size of the write buffer and the input/output queue would be larger than a combined write buffer and input/output queue. Memory controller 12 (and in some embodiments, memory controller 12 in combination with other control circuitry) makes sure that signals are not provided to be stored by buffer 54 when there is not room for them.

In some embodiments, control circuitry 52 causes a bit or bits to be set in buffer 54 or in other registers that differentiate between signals being received from receivers 42 and signals being received from receivers 62. For example, if the signals come from receivers 42, the bit might be “0” and if the signals come from receivers 62, the bit might be “1” or vice versa. In other embodiments, control circuitry 52 does not causes such a bit or bits to be set. For example, in some embodiments, there is another way to differentiate whether the signals come from receivers 42 or 62. In some embodiments, whether the signals come from receivers 42 or 62 can be ascertained based on the contents the signals. In other embodiments, control circuitry 52 designates certain portions of buffer 54 for signals from receivers 42 and others for signals from receivers 62. In some embodiments, this allocation is permanent and in other embodiments, the allocation can be changed depending on needs.

In some embodiments, if the signals are received from receivers 42, then the signals are provided to both memory core 60 and transmitters 66. In other embodiments, the signals might be provided to memory core 60, but not transmitters 66, or might be provided to transmitters 66, but not memory core 60, or they might be provided to both. In those embodiments that do not always send the signals to both, a reason to choose memory core 60 or transmitters 66 is that the address is to memory 20-1 or is not to memory 20-1. In those embodiments that always send the signals to both, memory core 60 or a memory core in the next memory chip or some other circuitry may determine whether the signals should be stored in the particular memory core. In other embodiments, other techniques may be used.

In some embodiments, receivers 42 receive only write data signals and receivers 62 receive only read data signals, with other types of signals being received by other receivers. In other embodiments, receivers 42 receive command and address signals and also include write data signals. Note that the received signals may change form and be repeater or recreated and still be considered the received signals, because the reformed, repeated or recreated signals carry the information of the received signals. Some signals are received by receivers 42 that are provide to buffer 50, but which are not provided by buffer 50 to write drivers 56 or transmitters 66. In some embodiments, all of receivers 42 are used to receive signals, all of receivers 62 are used to receive signals, all of transmitters 46 are used to transmit signals, and all of transmitters 66 are used to transmit signals. However, in some embodiments, some signals may be received by only a portion of the receivers 42 or by only a portion receivers 62, or transmitted by only a portion of transmitters 46 or by only a portion of transmitters 66. Even though particular signals are received by only a portion of receivers 42, for example, it still may be said that the signals are received by receivers 42. Likewise, even through particular signals are transmitters by only a portion of transmitters 66, for example, it still may be said that the signals are transmitted by transmitters 66.

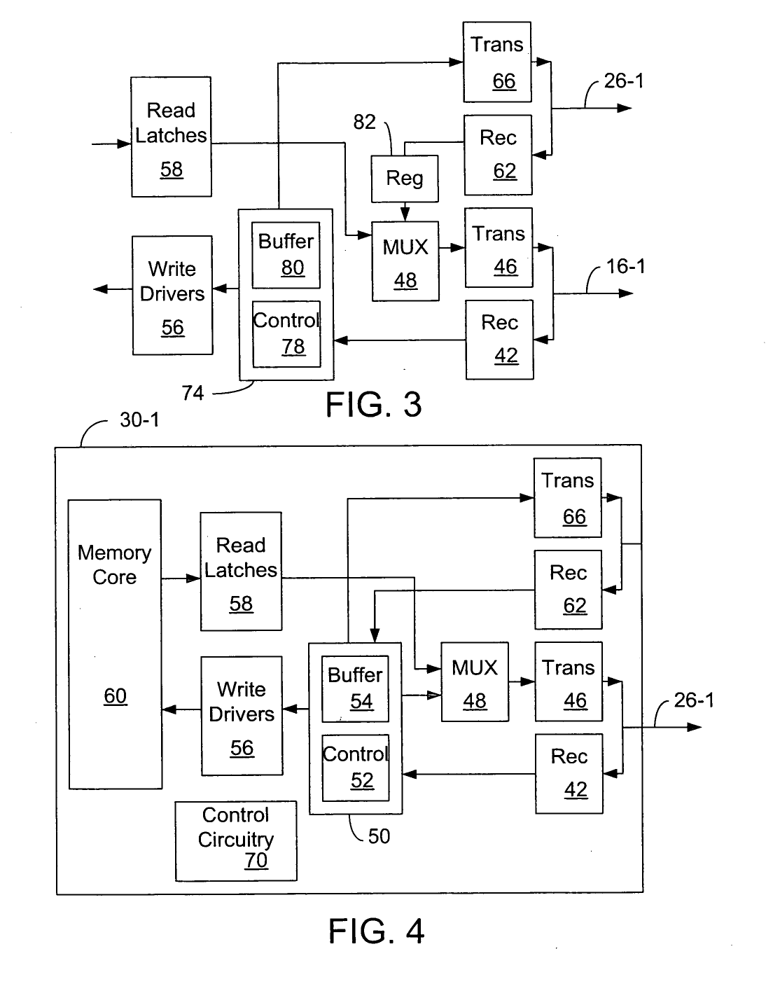

FIG. 3 illustrates other embodiments which are similar to the circuitry of FIG. 2 except that signals from receivers 62 are provided to registers 82 rather than to buffer circuitry 74 (buffer circuitry 50 in FIG. 2). Registers 82 provide the received signals to multiplexer circuitry 48. Buffer circuitry 74 (having control circuitry 78 and buffer 80) is similar to buffer circuitry 50 of FIG. 2 except that it does not provide signals from receivers 62 to multiplexer circuitry 48, as mentioned.

FIG. 4 illustrates an example of details of chip 30-1 in the case in which module 32 is coupled to only module 22 and not to an additional module. In the example of FIG. 4, chip 30-1 is like chip 20-1 in FIG. 2 except that in FIG. 4 receivers 62 and transmitters 66 are not coupled to external conductors.

Chips 20-2 . . . 20-N may be the same as chip 20-1. Chips 30-1 . . . 30-N may be the same as chip 20-1 except that receivers 62 and transmitters 66 are not coupled to conductors. As a practical matter, it may be less expensive to have all the memory chips be manufactured to be identical, but that is not required.

In FIG. 1, only two modules are illustrated. However, in some embodiments, there are more than two modules. For example, module 32 could be coupled to an additional module so that module 32 is between module 22 and the additional module. There may be additional modules in parallel with modules 22 and 32 and with an additional module or modules coupled to module 32. There may be memory chips on only one side or on both sides of the module substrates. The memory chips may be accessed in ranks, although it is not required. In some embodiments, the system includes only one level of module deep, but could include more than one module in parallel. For example, there might not be module 32, although in such a case, there still could be an additional module or modules in parallel with module 22.

An advantage of having a single buffer circuitry 50 as opposed to a write buffer that is separate from an input/output queue may be greater with memory chips on the end module (module 32 in FIG. 2 or in system with only one module deep) because buffer 54 is not used as an input/output queue to a next memory chip (see FIG. 4) so the amount of buffer 54 available as a write buffer is greater.

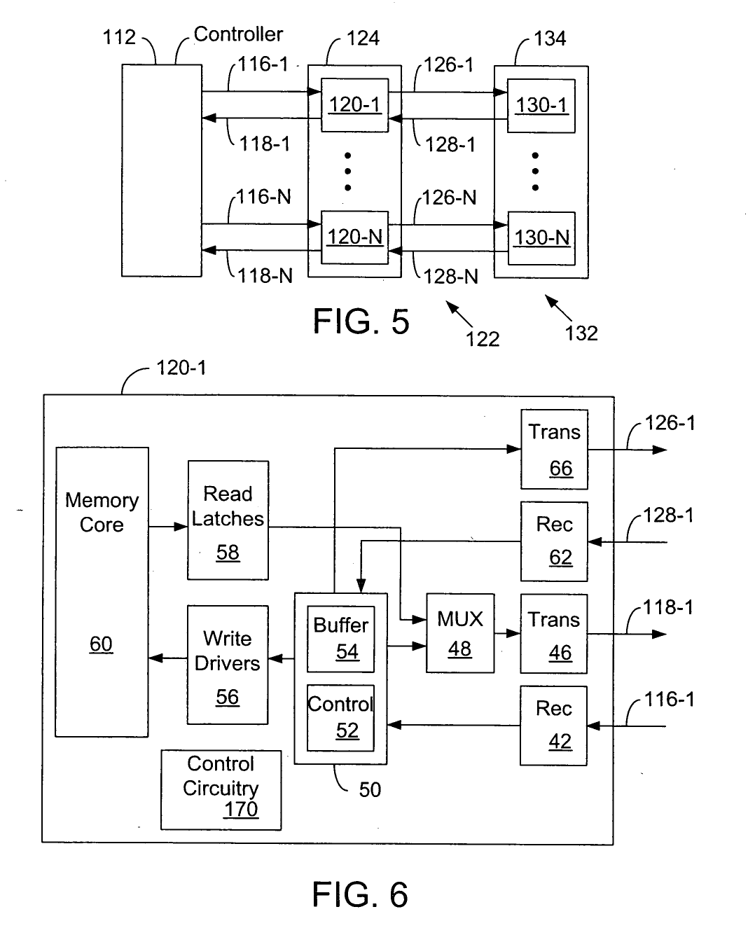

FIG. 5 illustrates a memory system including a memory controller 112 which is coupled to memory chips 120-1 . . . 120-N on a substrate 124 of a module 122 through conductors 116-1 . . . conductors 116-N and conductors 118-1 . . . conductors 118-N. Chips 120-1 . . . 120-N are in turn coupled to memory chips 130-1 . . . 130-N on a substrate 134 of a module 132 through conductors 126-1 . . . conductors 126-N and conductors 128-1 . . . 128-N. In the embodiments of FIG. 5, conductors 116-1 . . . conductors 116-N, conductors 118-1 . . . conductors 118-N, conductors 126-1 . . . conductors 126-N, and conductors 128-1 . . . conductors 128-N carry signals unidirectionally as shown by the arrows. There may also be other conductors (not illustrated in FIG. 5) that carry signals unidirectionally or bidirectionally.

FIG. 6 illustrates some details of chip 120-1 according to some embodiments. Of course, an actual chip may include circuitry in addition to what is illustrated in FIG. 6. Receivers 42, transmitters 46, receivers 62, and transmitters 66 are coupled to conductors 116-1, 118-1, 128-1, and 126-1. Receivers 42, transmitters 46, receivers 62, and transmitters 66 may be the same or somewhat different than the receivers and transmitters in FIG. 2. Control circuitry 170 performs various control functions for chip 120-1. Control circuitry 170 may be the same as or somewhat different than control circuitry 70. Multiplexer circuitry 48, buffer circuitry 50, write drivers 56, read latches 58, and memory core 60 may be the same as or somewhat different than multiplexer circuitry 48, buffer circuitry 50, write drivers 56, read latches 58, and memory core 60 in FIG. 2.

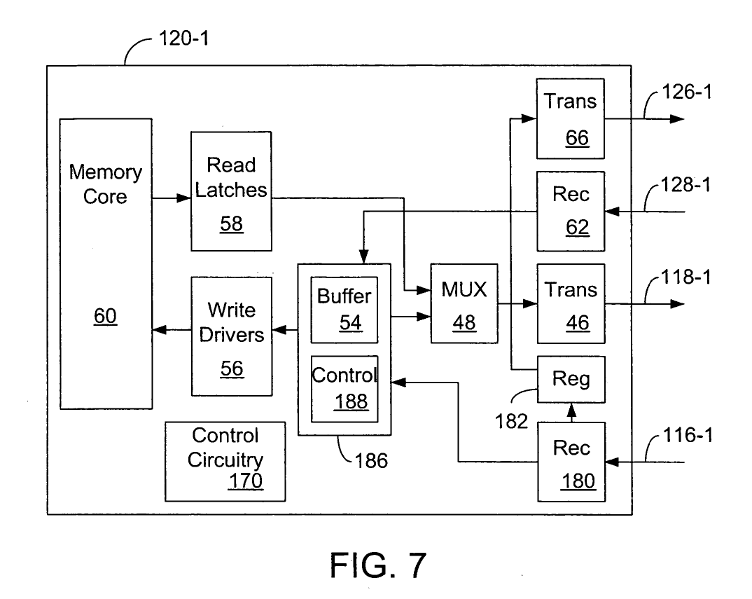

FIG. 7 illustrates an alternative embodiments of chip 120-1 which include registers 182 that receive signals from receivers 180. Registers 182 provide the received signals directly to transmitters 66 rather than going through buffer 186. Control circuitry 188 of buffer circuitry 186 may be somewhat different than control circuitry 52 because of the different routing of signals. Receivers 180 may be like receivers 42 except that they provide signals to both buffer circuitry 186 and to registers 182.

FIGS. 6 and 7 could be modified to include the arrangement shown in FIG. 3. FIGS. 2 and 3 could be modified to include registers like registers 182 of FIG. 7 to provides signals to transmitters 66.

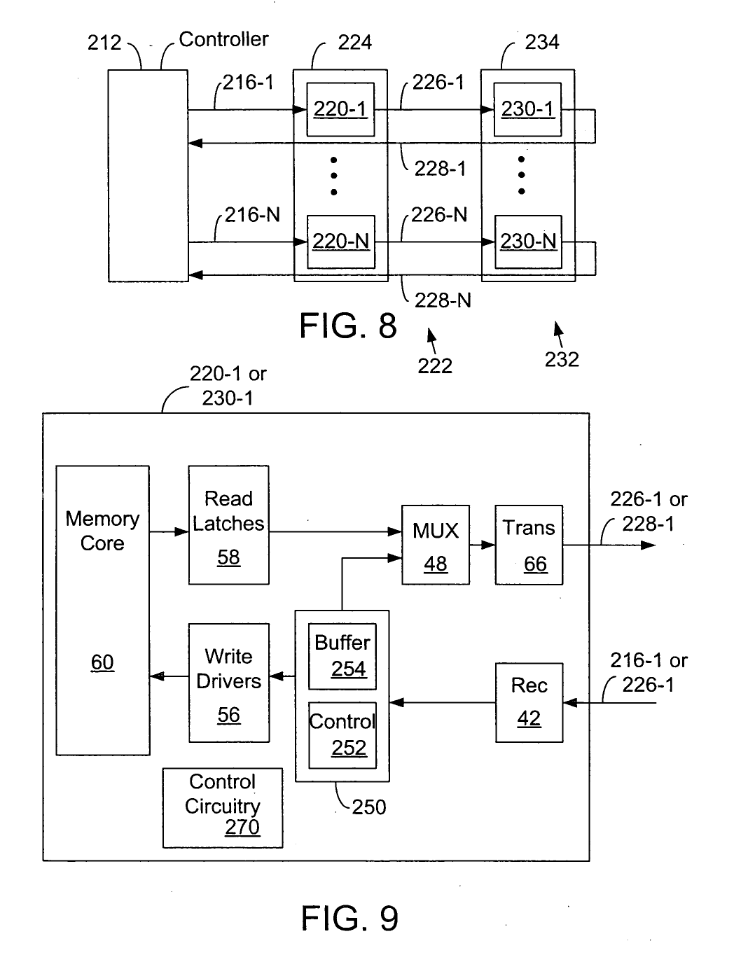

FIG. 8 illustrates a memory system including a memory controller 212 which is coupled to memory chips 220-1 . . . 220-N on a substrate 224 of a module 222 through conductors 216-1 . . . conductors 216-N. Chips 220-1 . . . 220-N are in turn coupled to memory chips 230-1 . . . 230-N on a substrate 234 of a module 232 through conductors 226-1 . . . conductors 226-N. Chips 230-1 . . . 230-N are in turn coupled to memory controller 212 through conductors 228-1 . . . conductors 228-N to form a ring. In the embodiments of FIG. 8, conductors 216-1 . . . conductors 216-N, conductors 226-1 . . . conductors 226-N, and conductors 228-1 . . . conductors 228-N carry signals unidirectionally as shown by the arrows. There may also be other conductors (not illustrated in FIG. 8) that carry signals unidirectionally or bidirectionally.

FIG. 9 illustrates examples of chips 220-1 and 230-1. In some embodiments (including those of FIG. 9) they are identical, although they not have to be identical in all embodiments. Receivers 42 receive signals from either conductors 216-1 or 226-1 depending on which chip is being illustrated. Buffer circuitry 250, which includes control circuitry 252 and buffer 254, receives signals from receivers 42. Buffer circuitry 250 provides the signals to memory core 60 through write drivers 56 and to transmitters 66 through multiplexer circuitry 48. Multiplexer circuitry 48 also receivers signals from read latches 58. Control circuitry 270 performs various control functions for chips 220-1 and 230-1. Control circuitry 270 may be the same as or somewhat different than control circuitry 70 and 170. Receivers 42, transmitters 66, write drivers 56, read latches 58, memory core 60, and multiplexer circuitry 48 may be the same as or somewhat different than receivers 42, transmitters 66, write drivers 56, read latches 58, memory core 60, and multiplexer circuitry 48 in FIG. 2.

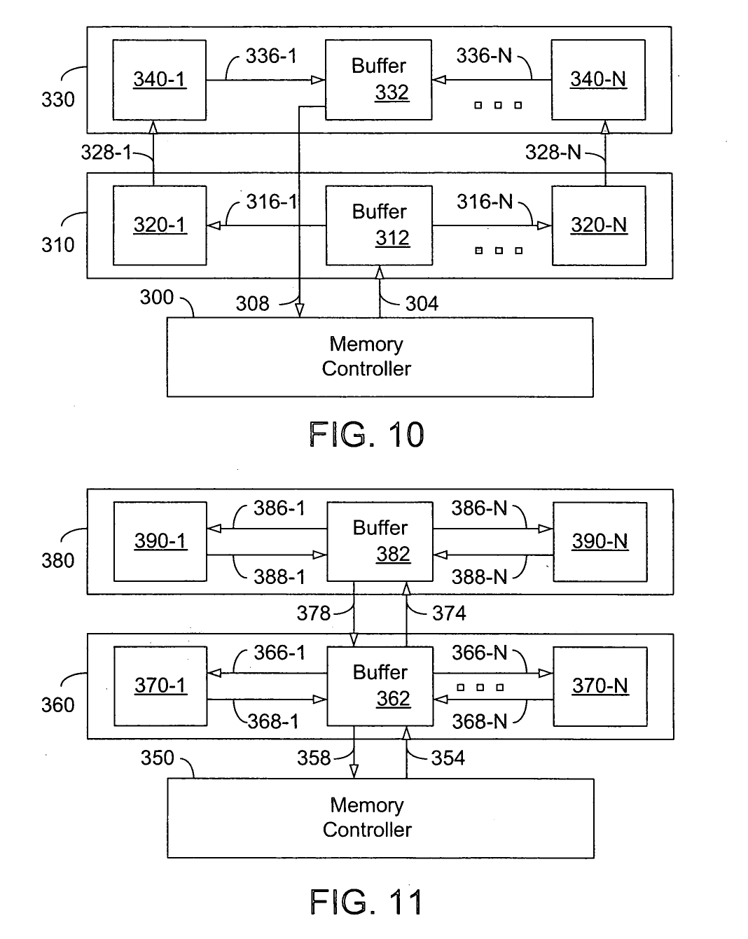

A buffer or buffers may be on the substrate with the memory chips and at least some of the signals received by or sent to the memory controller may pass through the buffer or buffers. In such a buffered system, the memory controller can use different signaling (for example, frequency and voltage values, and point-to-point versus a multi-drop arrangement) with the buffer than the buffer uses with the memory chips, or they may use the same signaling. FIGS. 10 and 11 illustrate two of the various possibilities of systems with buffers. The memory chips in FIGS. 10 and 11 may be the same as or similar to the memory chips in the other figures. There may be additional modules in the system and additional chips on the modules.

Referring to FIG. 10, a memory controller 300 is coupled through conductors 304 to a buffer 312 of a module with a substrate 310. Memory chips 320-1 . . . 320-N are coupled to buffer 312 through conductors 316-1 . . . conductors 316-N. Memory chips 340-1 . . . 340-N on substrate 330 are coupled to chips 320-1 . . . 320-N through conductors 328-1 . . . conductors 328-N, and are coupled to buffer 332 through conductors 336-1 . . . 336-N. Buffer 332 is coupled to memory controller 300 through conductors 308. The direction of signals is shown by arrows, but there could be additional conductors that carry unidirectional or bidirectional signals.

Referring to FIG. 11, a memory controller 350 is coupled through conductors 354 and conductors 358 to a buffer 362 of a module with a substrate 360. Memory chips 370-1 . . . 370-N are coupled to buffer 362 through conductors 366-1 . . . conductors 366-N and conductors 368-1 . . . conductors 368-N. Buffer 362 is coupled to buffer 382 through conductors 374 and conductors 378. Memory chips 390-1 . . . 390-N on a substrate 380 are coupled to buffer 382 through conductors 386-1 . . . conductors 386-N and conductors 388-1 . . . conductors 388-N. The direction of signals is shown by arrows, but there could be additional conductors that carry unidirectional or bidirectional signals.

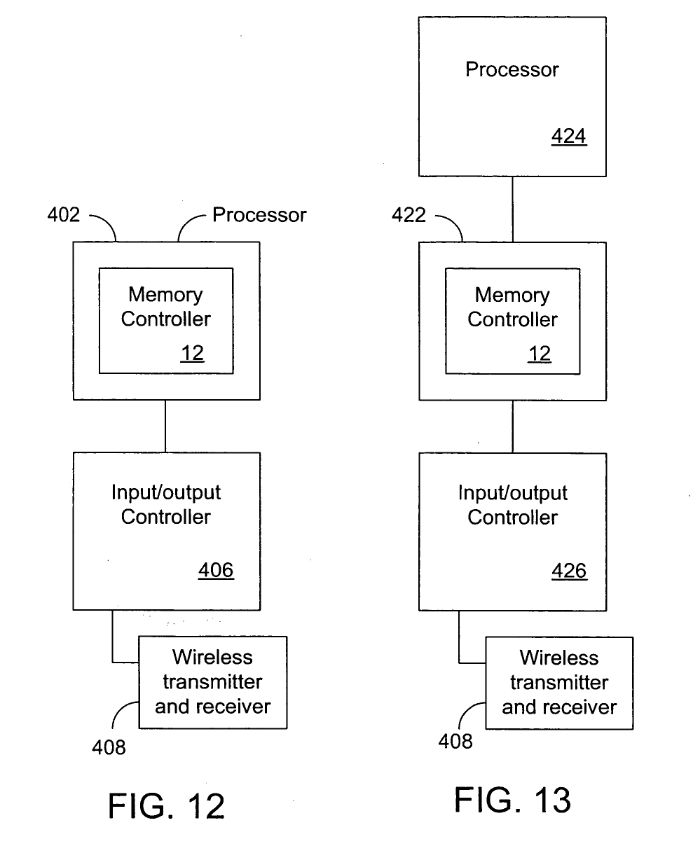

FIG. 12 illustrates a system in which memory controller 12 (or another controller in this disclosure) is in a chip 402, which also includes a computer system processor. Chip 402 could include multiple processors and multiple cores. Chip 402 is coupled to an input/output controller 406, which in turn is coupled to a wireless transmitter and receiver 408 for wireless communication. Wireless transmitter and receiver 408 are not required for all embodiments.

FIG. 13 illustrates a system in which memory controller 12 (or another controller in this disclosure) is in a chip 422, which is coupled to a processor chip 424, and is coupled to a input/output controller 426, which in turn is coupled to wireless transmitter and receiver 408 for wireless communication. In some embodiments, chip 422 interface with various other chips including graphics chips.

Additional Information and Embodiments

The inventions are not restricted to any particular signaling techniques or protocols. For example, the signaling may be single ended or differential. The signaling may include only two voltage levels or more than two voltage levels. The clock (or strobe) may be transmitted separately from the signals or embedded in the signals. Various coding techniques may be used. Serial or traditional parallel signaling may be used. The signals may be in packetized, multiplexed, or have dedicated lines. For example, command, address, write data signals may be packetized or time multiplexed. Or there could be dedicated lines for commands, dedicated lines for commands, and dedicated lines for write data or some combination of these. The inventions are not restricted to a particular type of transmitters and receivers. Various clocking techniques could be used in the transmitters and receivers and other circuits. The receiver symbols in the figures may include both the initial receiving circuits and the related latching and clocking circuits. According to certain terminology, in some embodiments, groups of conductors might be referred to links that includes lanes, but other types of signaling could be used.

Interconnections between control circuitry 70, 170, and 270 and other components are not shown to avoid clutter in the figures. There may be a variety of circuits which are not illustrated in the figures. When the figures show two blocks connected through conductors, there may be intermediate circuitry that is not illustrated. The shape and relative sizes of the blocks is not intended to relate to actual shapes and relative sizes.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” “some embodiments,” or “other embodiments” are not necessarily all referring to the same embodiments.

When it is said the element “A” is coupled to element “B,” element A may be directly coupled to element B or be indirectly coupled through, for example, element C.

When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.”

If the specification states a component, feature, structure, process, or characteristic “may”, “might”, or “could” be included, that particular component, feature, structure, process, or characteristic is not required to be included. If the specification or claim refers to “a” or “an” element, that does not mean there is only one of the element. If the specification or claims refer to “an additional” element, that does not preclude there being more than one of the additional element.

The inventions are not restricted to the particular details described herein. Indeed, many other variations of the foregoing description and drawings may be made within the scope of the present inventions. Accordingly, it is the following claims including any amendments thereto that define the scope of the inventions.

What is claimed is:

1. A memory chip comprising:
receivers to receive signals from outside the chip;
transmitters to transmit signals to outside the chip;
a memory core; and
buffer circuitry to hold the signals received by the receivers and, under at least some circumstances, to provide the held signals for use by both the memory core and the transmitters.

2. The chip of claim 1, wherein the held signals are provided for use by both the memory core and the transmitters under all circumstances.

3. The chip of claim 1, wherein under some circumstances, the held signals are provided for use by the memory core, but not the transmitters, and under other circumstances, the held signals are provided for use by the transmitters, but not the memory core.

4. The chip of claim 1, wherein buffer circuitry detects whether the received signals are for the memory core or the transmitters.

5. The chip of claim 1, further comprising multiplexer circuitry and read latches to receive read signals from the memory core and provide them to the multiplexer circuitry, and wherein the buffer circuitry provides the held signals to the transmitters through the multiplexer circuitry.

6. The chip of claim 1, wherein bits representing the held signals are provided by the buffer circuitry toward the memory core and toward the transmitters at the same time.

7. The chip of claim 1, wherein bits representing the held signals are provided by the buffer circuitry toward the memory core and toward the transmitters at the different times.

8. The chip of claim 1, wherein some of the signals are received by only a portion of the receivers, and some of the held signals.

9. The chip of claim 1, further comprising write drivers coupled between the buffer circuitry and the memory core, wherein the write drivers receive the signals from the buffer circuitry and drives them to the memory core.

10. The chip of claim 1, wherein the receivers are a first group of receivers and the transmitters are a second group of transmitters, and the chip further comprises a second group of receivers and first group of transmitters.

11. The chip of claim 10, further comprising multiplexer circuitry and wherein the buffer circuitry is to hold the signals received by the second group of receivers and to provide the held signals of the second group of receivers to the first group of transmitters through the multiplexer circuitry.

12. The chip of claim 11, further comprising read latches to receive read signals from the memory core and provide them to the multiplexer circuitry.

13. The chip of claim 10, wherein some of the signals are received by only a portion of the first group of receivers and some of the signals are received by only a portion of the second group of receivers, and some of the signals received by the buffer circuitry from the first group of receivers are provided to only some of the second group of transmitters, and some of the signals received by the buffer circuitry from the second group of receivers are provided to only some of the first group of transmitters.

14. A memory chip comprising:
receivers to receive signals from outside the chip;
transmitters to transmit signals to outside the chip;
a memory core;
registers to hold the signals received by the receivers and to provide the held signals to the transmitters; and
buffer circuitry to hold the signals received by the receivers and to provide the held signals for use by the memory core.

15. The chip of claim 14, wherein the receivers are a first group of receivers and the transmitters are a second group of transmitters, and the chip further comprises a second group of receivers and first group of transmitters.

16. The chip of claim 15, further comprising multiplexer circuitry, and read latches to receive signals from the memory core and provide them to the multiplexer circuitry and wherein the buffer circuitry receives signals from the second group of receivers and provides them to the multiplexer circuitry.

17. A system comprising:
a memory controller; and
memory chips coupled to the memory controller, wherein the memory chips each include:
receivers to receive signals from outside the chip;
transmitters to transmit signals to outside the chip;
a memory core; and
buffer circuitry to hold the signals received by the receivers and, under at least some circumstances, to provide the held signals for use by both the memory core and the transmitters.

18. The system of claim 17, further comprising a group of conductors coupled between the memory controller and the transmitters and receivers.

19. The system of claim 17, further comprising a first group of conductors coupled between the memory controller and the receivers, and a second group of conductors coupled between the memory controller and the transmitters.

20. The system of claim 17, further comprising multiplexer circuitry and read latches read latches to receive read signals from the memory core and provide them to the multiplexer circuitry, and wherein the buffer circuitry provides the held signals to the transmitters through the multiplexer circuitry.

21. The system of claim 17, further comprising a buffer between the memory controller and the memory chips.

22. The system of claim 17, wherein the memory controller is in a chip that includes a processor.

23. The system of claim 17, wherein the receivers are a first group of receivers and the transmitters are a second group of transmitters, and the chip further comprises a second group of receivers and first group of transmitters.

24. The system of claim 23, further comprising multiplexer circuitry and wherein the buffer circuitry is to hold the signals received by the second group of receivers and to provide the held signals of the second group of receivers to the first group of transmitters through the multiplexer circuitry.

25. The system of claim 24, further comprising read latches to receive read signals from the memory core and provide them to the multiplexer circuitry.

26. A system comprising:
a memory controller; and
memory chips coupled to the memory controller, wherein the memory chips each include:
receivers to receive signals from outside the chip;
transmitters to transmit signals to outside the chip;
a memory core;
registers to hold the signals received by the receivers and to provide the held signals to the transmitters; and
buffer circuitry to hold the signals received by the receivers and to provide the held signals for use by the memory core.

27. The system of claim 26, wherein the receivers are a first group of receivers and the transmitters are a second group of transmitters, and the chip further comprises a second group of receivers and first group of transmitters.

28. The system of claim 27, further comprising multiplexer circuitry, and read latches to receive signals from the memory core and provide them to the multiplexer circuitry and wherein the buffer circuitry receives signals from the second group of receivers and provides them to the multiplexer circuitry.
